(19) United States
(12) Patent Application Publication
(10) Pub. No.: US 2024/0275960 A1
(43) Pub. Date: Aug. 15, 2024

(54) HIGH-LEVEL SYNTAX FOR PICTURE RESAMPLING

(71) Applicant: InterDigital CE Patent Holdings, SAS, Paris (FR)

(72) Inventors: Tangi Poirier, Thorigne-Fouillard (FR); Fabrice Le Leannec, Betton (FR); Karam Naser, Mouaze (FR); Gaëlle Martin-Cocher, Toronto (CA)

(21) Appl. No.: 18/568,132

(22) PCT Filed: May 23, 2022
(86) PCT No.: PCT/EP2022/063898

§ 371 Date: Dec. 7, 2023

(30) Foreign Application Priority Data
Jun. 11, 2021 (EP) 21305804.3

(51) Int. Cl. H04N 19/117; H04N 19/132; H04N 19/136; H04N 19/172; H04N 19/186; H04N 19/70

(52) U.S. Cl. CPC H04N 19/117; H04N 19/132; H04N 19/136; H04N 19/172; H04N 19/186; H04N 19/70

(57) ABSTRACT

A method comprising: decoding (701) a picture of a plurality of pictures representing a video sequence from video data; obtaining (702) parameters of a filter determined from metadata associated to the video data, the metadata comprising at least one first information specifying a subset of the plurality of pictures on which the filter is to be applied; and, applying (703) the filter on the decoded picture responsive to the metadata.

### 1. TECHNICAL FIELD

At least one of the present embodiments generally relates to a method, an apparatus and a signal for controlling a post-filtering process intended to resample pictures of a video content.

### 2. BACKGROUND

To achieve high compression efficiency, video coding schemes usually employ predictions and transforms to leverage spatial and temporal redundancies in a video content. During an encoding, pictures of the video content are divided into blocks of samples (i.e. Pixels), these blocks being then partitioned into one or more sub-blocks, called original sub-blocks in the following. An intra or inter prediction is then applied to each sub-block to exploit intra or inter image correlations. Whatever the prediction method used (intra or inter), a predictor sub-block is determined for each original sub-block. Then, a sub-block representing a difference between the original sub-block and the predictor sub-block, often denoted as a prediction error sub-block, a prediction residual sub-block or simply a residual sub-block, is transformed, quantized and entropy coded to generate an encoded video stream. To reconstruct the video, the compressed data is decoded by inverse processes corresponding to the transform, quantization and entropic coding.

Last generations of video compression standards, such as MPEG-4/AVC (ISO/CEI 14496-10), HEVC (ISO/IEC 23008-2-MPEG-H Part 2, High Efficiency Video Coding/ITU-T H.265)) or the international standard entitled Versatile Video Coding (VVC) under development by a joint collaborative team of ITU-T and ISO/IEC experts known as the Joint Video Experts Team (JVET) all favor the use of post-filtering through the definition of adapted metadata. For instance, Supplemental enhanced information (SEI) messages were defined to convey some post-filtering parameters.

In VVC, a new tool, called Reference Picture Resampling (RPR), allows encoding sequences of pictures wherein the pictures resolutions are heterogeneous.

FIG. 1 represents an application of the RPR tool. In FIG. 1, picture 4 is temporally predicted from picture 3. Picture 3 is temporally predicted from picture 2. Picture 2 is temporally predicted from picture 1. Since picture 4 and picture 3 have different resolutions, picture 3 is up-sampled to picture 4 resolution during the decoding process. Picture 3 and 2 have the same resolution. No up-sampling nor down-sampling is applied to picture 2 for the temporal prediction. Picture 1 is larger than picture 2. A down-sampling is applied to picture 1 for the temporal prediction of picture 2 during the decoding process. However, the resampling process applied for temporal prediction is generally applied at the block level so that, no resampled picture is available at the output of the decoder. Only pictures at their reconstructed resolution are available, a video sequence encoded with pictures at different resolutions being outputted with pictures at their encoded resolutions. A resampling post-filtering process is therefore required to homogenize the pictures resolutions.

Post-filtering SEI messages defined until now were mainly designed to specify filters intended to improve the output picture subjective quality. These SEI messages were not designed for specifying resampling filters and a fortiori not designed for video sequences comprising pictures with heterogeneous resolutions. Indeed, these SEI messages were designed to post-filter identically all pictures of a video sequence while a resampling post-filtering process intended to homogenize the picture resolutions cannot process identically pictures of different resolutions.

It is desirable to propose solutions allowing to overcome the above issues. In particular, it is desirable to propose a solution allowing specifying resampling post-filters and adapted to the particular case of video sequence with heterogenous encoded resolutions requiring an homogenization of these resolutions.

### 3. BRIEF SUMMARY

In a first aspect, one or more of the present embodiments provide a method comprising:
decoding a current picture of a plurality of pictures representing a video sequence from a portion of a bitstream; obtaining parameters of a filter determined from metadata embedded in the bitstream, the metadata comprising at least one first information specifying a subset of the plurality of pictures on which the filter is to be applied; and, applying the filter on the decoded current picture responsive to the metadata.

In an embodiment, the filter is a resampling filter.

In an embodiment, the filter is a separable filter and the metadata specifies parameters of an horizontal filter and parameters of a vertical filter.

In an embodiment, the filter is intended to be applied to luma and chroma components of each picture of the subset of pictures and the metadata specifies parameters of the filter adapted for the filtering of the luma component and parameters of the filter adapted for the filtering of the chroma components different from the parameters of the filter adapted for the filtering of the luma components.

In an embodiment, the at least one first information specifies that the filter is applied only to pictures that have a resolution different from a maximum resolution.

In an embodiment, the metadata comprises a second information specifying a filtering method in a plurality of filtering methods.

In an embodiment, the plurality of filtering methods comprises a luma filtering, a chroma filtering, a bilinear filtering, a Directional Cubic Convolution Interpolation, an Iterative Curvature-based Interpolation, a Edge-Guided Image Interpolation, and a deep learning based filtering method.

In a second aspect, one or more of the present embodiments provide a method comprising:
encoding a plurality of pictures representing a video sequence in a portion of a bitstream; and, encoding metadata representative of a filter in the bitstream, the metadata comprising at least one first information specifying a subset of the plurality of pictures on which the filter is to be applied.

In an embodiment, the filter is a resampling filter.

In an embodiment, the filter is a separable filter and the metadata specifies parameters of an horizontal filter and parameters of a vertical filter.

In an embodiment, the filter is intended to be applied to luma and chroma components of each picture of the subset of pictures and the metadata specifies parameters of the filter adapted for the filtering of the luma component and parameters of the filter adapted for the filtering of the chroma components different from the parameters of the filter adapted for the filtering of the luma components.

In an embodiment, the at least one first information specifies that the filter is applied only to pictures that have a resolution different from a maximum resolution.

In an embodiment, the metadata comprises a second information specifying a filtering method in a plurality of filtering methods.

In an embodiment, the plurality of filtering methods comprises a luma filtering, a chroma filtering, a bilinear filtering, a Directional Cubic Convolution Interpolation, an Iterative Curvature-based Interpolation, an Edge-Guided Image Interpolation, and a deep learning based filtering method.

In a third aspect, one or more of the present embodiments provide a device comprising electronic circuitry adapted for:
decoding a current picture of a plurality of pictures representing a video sequence from a portion of a bitstream; obtaining parameters of a filter determined from metadata embedded in the bitstream, the metadata comprising at least one first information specifying a subset of the plurality of pictures on which the filter is to be applied; and, applying the filter on the decoded current picture responsive to the metadata.

In an embodiment, the filter is a resampling filter.

In an embodiment, the filter is a separable filter and the metadata specifies parameters of an horizontal filter and parameters of a vertical filter.

In an embodiment, the filter is intended to be applied to luma and chroma components of each picture of the subset of pictures and the metadata specifies parameters of the filter adapted for the filtering of the luma component and parameters of the filter adapted for the filtering of the chroma components different from the parameters of the filter adapted for the filtering of the luma components.

In an embodiment, the at least one first information specifies that the filter is applied only to pictures that have a resolution different from a maximum resolution.

In an embodiment, the metadata comprises a second information specifying a filtering method in a plurality of filtering methods.

In an embodiment, the plurality of filtering methods comprises a luma filtering, a chroma filtering, a bilinear filtering, a Directional Cubic Convolution Interpolation, an Iterative Curvature-based Interpolation, a Edge-Guided Image Interpolation, and a deep learning based filtering method.

In a fourth aspect, one or more of the present embodiments provide a device comprising electronic circuitry adapted for:
encoding a plurality of pictures representing a video sequence in a portion of a bitstream; and, encoding metadata representative of a filter in the bitstream, the metadata comprising at least one first information specifying a subset of the plurality of pictures on which the filter is to be applied.

In an embodiment, the filter is a resampling filter.

In an embodiment, the filter is a separable filter and the metadata specifies parameters of an horizontal filter and parameters of a vertical filter.

In an embodiment, the filter is intended to be applied to luma and chroma components of each picture of the subset of pictures and the metadata specifies parameters of the filter adapted for the filtering of the luma component and parameters of the filter adapted for the filtering of the chroma components different from the parameters of the filter adapted for the filtering of the luma components.

In an embodiment, the at least one first information specifies that the filter is applied only to pictures that have a resolution different from a maximum resolution.

In an embodiment, the metadata comprise a second information specifying a filtering method in a plurality of filtering methods.

In an embodiment, the plurality of filtering methods comprises a luma filtering, a chroma filtering, a bilinear filtering, a Directional Cubic Convolution Interpolation, an Iterative Curvature-based Interpolation, an Edge-Guided Image Interpolation, and a deep learning based filtering method.

In a fifth aspect, one or more of the present embodiments provide a signal comprising metadata representative of a filter and associated to a plurality of pictures representing a video sequence, the metadata comprising at least one information specifying a subset of the plurality of pictures on which the filter is to be applied.

In a sixth aspect, one or more of the present embodiments provide a computer program comprising program code instructions for implementing the method according to the first or the second aspect.

In a seventh aspect, one or more of the present embodiments provide a non-transitory information storage medium storing program code instructions for implementing the method according to the first or the second aspect.

### 4. BRIEF SUMMARY OF THE DRAWINGS

FIG. 1 represents an application of the reference picture resampling tool;

FIG. 2 illustrates schematically an example of partitioning undergone by a picture of pixels of an original video;

FIG. 3 depicts schematically a method for encoding a video stream;

FIG. 4 depicts schematically a method for decoding an encoded video stream;

FIG. 5A illustrates schematically an example of video streaming system in which embodiments are implemented;

FIG. 5B illustrates schematically an example of hardware architecture of a processing module able to implement an encoding module or a decoding module in which various aspects and embodiments are implemented;

FIG. 5C illustrates a block diagram of an example of a first system in which various aspects and embodiments are implemented;

FIG. 5D illustrates a block diagram of an example of a second system in which various aspects and embodiments are implemented;

FIG. 6 illustrates schematically an example of a method for encoding pictures of a video sequence along with metadata allowing controlling a resampling of these pictures; and,

FIG. 7 represents schematically an example of a method for reconstructing pictures comprising a resampling of these pictures responsive to the metadata.

### 5. DETAILED DESCRIPTION

The following examples of embodiments are described in the context of a video format similar to VVC. However, these embodiments are not limited to the video coding/decoding method corresponding to VVC. These embodiments are in particular adapted to any video format allowing generating video streams comprising pictures having different resolutions and/or in which the reconstructed resolution of a picture could be different from its display resolution. Such formats comprise for example the standard HEVC, S-HVC (Scalable High Efficiency Video Coding), AVC, SVC (Scalable Video Coding), EVC (Essential Video Coding/MPEG-5), AV1 and VP9.

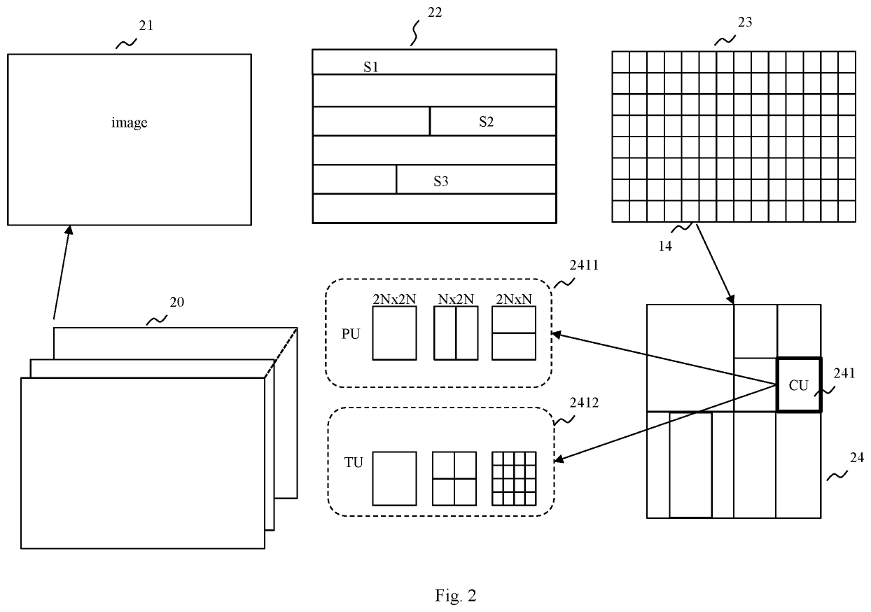

FIGS. 2, 3 and 4 introduce an example of video format.

FIG. 2 illustrates an example of partitioning undergone by a picture of pixels 21 of an original video sequence 20. It is considered here that a pixel is composed of three components: a luminance component and two chrominance components. Other types of pixels are however possible comprising less or more components such as only a luminance component or an additional depth component or transparency component.

A picture is divided into a plurality of coding entities. First, as represented by reference 23 in FIG. 2, a picture is divided in a grid of blocks called coding tree units (CTU). A CTU consists of an N×N block of luminance samples together with two corresponding blocks of chrominance samples. N is generally a power of two having a maximum value of “128” for example. Second, a picture is divided into one or more groups of CTU. For example, it can be divided into one or more tile rows and tile columns, a tile being a sequence of CTU covering a rectangular region of a picture. In some cases, a tile could be divided into one or more bricks, each of which consisting of at least one row of CTU within the tile. Above the concept of tiles and bricks, another encoding entity, called slice, exists, that can contain at least one tile of a picture or at least one brick of a tile.

In the example in FIG. 2, as represented by reference 22, the picture 21 is divided into three slices S1, S2 and S3 of the raster-scan slice mode, each comprising a plurality of tiles (not represented), each tile comprising only one brick.

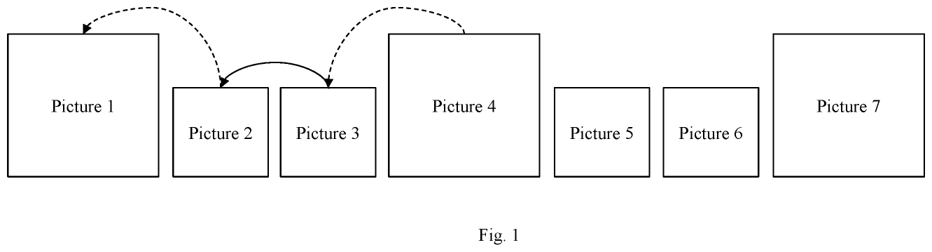

As represented by reference 24 in FIG. 1, a CTU may be partitioned into the form of a hierarchical tree of one or more sub-blocks called coding units (CU). The CTU is the root (i.e. the parent node) of the hierarchical tree and can be partitioned in a plurality of CU (i.e. child nodes). Each CU becomes a leaf of the hierarchical tree if it is not further partitioned in smaller CU or becomes a parent node of smaller CU (i.e. child nodes) if it is further partitioned.

In the example of FIG. 1, the CTU 14 is first partitioned in “4” square CU using a quadtree type partitioning. The upper left CU is a leaf of the hierarchical tree since it is not further partitioned, i.e. it is not a parent node of any other CU. The upper right CU is further partitioned in “4” smaller square CU using again a quadtree type partitioning. The bottom right CU is vertically partitioned in “2” rectangular CU using a binary tree type partitioning. The bottom left CU is vertically partitioned in “3” rectangular CU using a ternary tree type partitioning.

During the coding of a picture, the partitioning is adaptive, each CTU being partitioned so as to optimize a compression efficiency of the CTU criterion.

In HEVC appeared the concept of prediction unit (PU) and transform unit (TU). Indeed, in HEVC, the coding entity that is used for prediction (i.e. a PU) and transform (i.e. a TU) can be a subdivision of a CU. For example, as represented in FIG. 1, a CU of size 2N×2N, can be divided in PU 2411 of size N×2N or of size 2N×N. In addition, said CU can be divided in “4” TU 2412 of size N×N or in “16” TU of size

$$( \frac{N}{2} ) \times ( \frac{N}{2} ) .$$

One can note that in VVC, except in some particular cases, frontiers of the TU and PU are aligned on the frontiers of the CU. Consequently, a CU comprises generally one TU and one PU.

In the present application, the term “block” or “picture block” can be used to refer to any one of a CTU, a CU, a PU and a TU. In addition, the term “block” or “picture block” can be used to refer to a macroblock, a partition and a sub-block as specified in H.264/AVC or in other video coding standards, and more generally to refer to an array of samples of numerous sizes.

In the present application, the terms “reconstructed” and “decoded” may be used interchangeably, the terms “pixel” and “sample” may be used interchangeably, the terms “image,” “picture”, “sub-picture”, “slice” and “frame” may be used interchangeably. Usually, but not necessarily, the term “reconstructed” is used at the encoder side while “decoded” is used at the decoder side.

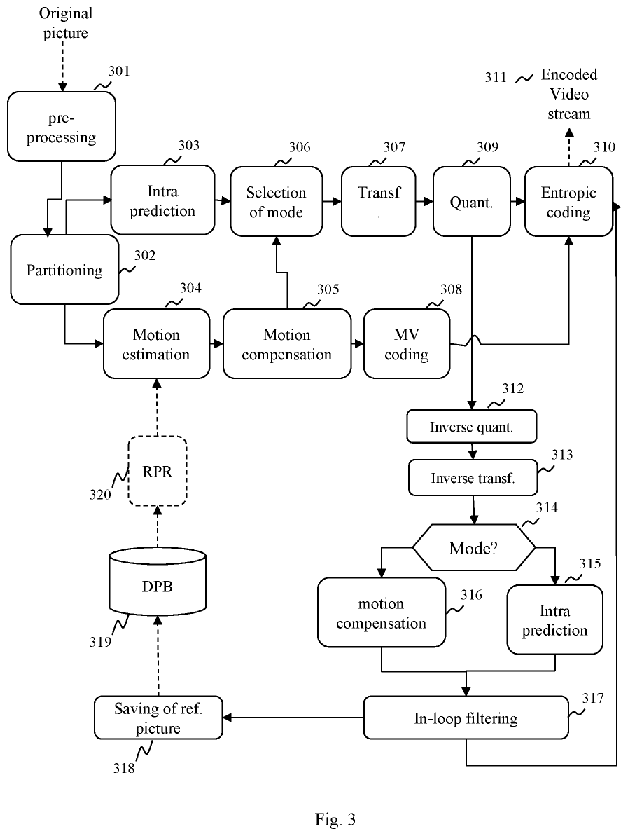

FIG. 3 depicts schematically a method for encoding a video stream executed by an encoding module. Variations of this method for encoding are contemplated, but the method for encoding of FIG. 3 is described below for purposes of clarity without describing all expected variations.

Before being encoded, a current original image of an original video sequence may go through a pre-processing. For example, in a step 301, a color transform is applied to the current original picture (e.g., conversion from RGB 4:4:4 to YCbCr 4:2:0), or a remapping is applied to the current original picture components in order to get a signal distribution more resilient to compression (for instance using a histogram equalization of one of the color components). In addition, the pre-processing 301 may comprise a resampling (a down-sampling or an up-sampling). The resampling may be applied to some pictures so that the generated bitstream may comprise pictures at the original resolution and picture at another resolution. The resampling consists generally in a down-sampling and is used to reduce the bitrate of the generated bitstream. Nevertheless, up-sampling is also possible. Pictures obtained by pre-processing are called pre-processed pictures in the following.

The encoding of a pre-processed picture begins with a partitioning of the pre-processed picture during a step 302, as described in relation to FIG. 1. The pre-processed picture is thus partitioned into CTU, CU, PU, TU, etc. For each block, the encoding module determines a coding mode between an intra prediction and an inter prediction.

The intra prediction consists of predicting, in accordance with an intra prediction method, during a step 303, the pixels of a current block from a prediction block derived from pixels of reconstructed blocks situated in a causal vicinity of the current block to be coded. The result of the intra prediction is a prediction direction indicating which pixels of the blocks in the vicinity to use, and a residual block resulting from a calculation of a difference between the current block and the prediction block.

The inter prediction consists of predicting the pixels of a current block from a block of pixels, referred to as the reference block, of a picture preceding or following the current picture, this picture being referred to as the reference picture. During the coding of a current block in accordance with the inter prediction method, a block of the reference picture closest, in accordance with a similarity criterion, to the current block is determined by a motion estimation step 304. During step 304, a motion vector indicating the position of the reference block in the reference picture is determined. Said motion vector is used during a motion compensation step 305 during which a residual block is calculated in the form of a difference between the current block and the reference block. In first video compression standards, the mono-directional inter prediction mode described above was the only inter mode available. As video compression standards evolve, the family of inter modes has grown significantly and comprises now many different inter modes.

During a selection step 306, the prediction mode optimising the compression performances, in accordance with a rate/distortion optimization criterion (i.e. RDO criterion), among the prediction modes tested (Intra prediction modes, Inter prediction modes), is selected by the encoding module.

When the prediction mode is selected, the residual block is transformed during a step 307 and quantized during a step 309. Note that the encoding module can skip the transform and apply quantization directly to the non-transformed residual signal. When the current block is coded according to an intra prediction mode, a prediction direction and the transformed and quantized residual block are encoded by an entropic encoder during a step 310. When the current block is encoded according to an inter prediction, when appropriate, a motion vector of the block is predicted from a prediction vector selected from a set of motion vectors corresponding to reconstructed blocks situated in the vicinity of the block to be coded. The motion information is next encoded by the entropic encoder during step 310 in the form of a motion residual and an index for identifying the prediction vector. The transformed and quantized residual block is encoded by the entropic encoder during step 310. Note that the encoding module can bypass both transform and quantization, i.e., the entropic encoding is applied on the residual without the application of the transform or quantization processes. The result of the entropic encoding is inserted in an encoded video stream 311.

Metadata such as SEI (supplemental enhancement information) messages can be attached to the encoded video stream 311. A SEI message as defined for example in standards such as AVC, HEVC or VVC is a data container associated to a video stream and comprising metadata providing information relative to the video stream.

Some SEI messages were defined to transport post-filtering information. An example of such SEI message is depicted in table TAB1.

TABLE TAB1

```
post_filter_hint( payloadSize ) {
  filter_hint_size_y
  filter_hint_size_x
  filter_hint_type
  for( cIdx = 0; cIdx < ( chroma_format_idc = = 0 ? 1 : 3 );
cIdx++ )
    for( cy = 0; cy < filter_hint_size_y; cy ++ )
      for( cx = 0; cx < filter_hint_size_x; cx ++ )
        filter_hint_value[ cIdx ][ cy ][ cx ]
}
```

Said SEI message allows defining a filter for post-filtering pictures. This SEI message provides coefficients of a post-filter or correlation information for the design of a post-filter. This SEI message was typically designed for post-filters allowing improving a subjective quality of pictures outputted by a decoder.

In this SEI message:
filter_hint_size_y is a syntax element specifying a vertical size of the filter coefficients array or correlation array. The value of filter_hint_size_y shall be in the range of “1” to “15”, inclusive.
filter_hint_size_x is a syntax element specifying the horizontal size of the filter coefficients array or correlation array. The value of filter_hint_size_x shall be in the range of “1” to “15”, inclusive.
filter_hint_type is a syntax element identifying a type of the transmitted filter hints as specified in Table TAB2 below. Values of_filter_hint_type shall be in the range of “0” to “2”, inclusive. A value of filter_hint_type equal to “3” is reserved for future use. Decoders shall ignore post-filter hint SEI messages having filter_hint_type equal to “3”.

TABLE TAB2

| Value | Description |
|---|---|
| 0 | Coefficients of a 2D-FIR filter |
| 1 | Coefficients of two 1D-FIR filters |
| 2 | Cross-correlation matrix |

filter_hint_value[cIdx][cy][cx] is a syntax element specifying a filter coefficient or an element of a cross-correlation matrix between the original and the decoded signal with 16-bit precision. The value of filter_hint_value[cIdx][cy][cx] shall be in the range of −2³¹+1 to 2³¹−1, inclusive. cIdx specifies the related colour component, cy represents a counter in vertical direction and cx represents a counter in horizontal direction. Depending on the value of filter_hint_type, the following applies:
If filter_hint_type is equal to “0”, the coefficients of a 2-dimensional finite impulse response (FIR) filter with the size of filter_hint_size_y*filter_hint_size_x are transmitted.
Otherwise, if filter_hint_type is equal to “1”, the filter coefficients of two 1-dimensional FIR filters are transmitted. In this case, filter_hint_size_y shall be equal to “2”. The index cy equal to “0” specifies the filter coefficients of the horizontal filter and cy equal to “1” specifies the filter coefficients of the vertical filter. In the filtering process, the horizontal filter is applied first and the result is filtered by the vertical filter.
Otherwise (filter_hint_type is equal to “2”), the transmitted hints specify a cross-correlation matrix between the original signal and the decoded signal.

One limitation of the SEI message of table TAB1 is that it doesn't allow specifying a duration or a time interval for the applicability of this SEI message. This SEI message is applied at the sequence level and its applicability does not depend on the picture resolution. Another limitation is that the number of types of filter that can be specified by this SEI message is limited. For instance, it cannot specify filters based on neural networks which are the last generation of filters. In addition, only filters intended to improve the visual (subjective) quality of pictures can be specified. Resampling filters cannot be specified.

Another SEI message was defined to transport resampling information specifically dedicated to chroma. This SEI message is the depicted in table TAB3.

```
TABLE TAB3
chroma_resampling_filter_hint( payloadSize ) {
  ver_{—}chroma_{—}filter_{—}idc
  hor_{—}chroma_{—}filter_{—}idc
  ver_{—}filtering_{—}field_{—}processing_{—}flag
  if( ver_chroma_filter_idc = = 1 ∥ hor_chroma_filter_idc = = 1 ) {
    target_{—}format_{—}idc
    if( ver_chroma_filter_idc = = 1 ) {
      num_{—}vertical_{—}filters
      for( i = 0; i < num_vertical_filters; i++ ) {
        ver_{—}tap_{—}length_{—}minus1[ i ]
        for( j = 0; j <= ver_tap_length_minus1[ i ]; j++ )
          ver_{—}filter_{—}coeff[ i ][ j ]
      }
    }
    if( hor_chroma_filter_idc = = 1 ) {
      num_{—}horizontal_{—}filters
      for( i = 0; i < num_horizontal_filters; i++ ) {
        hor_{—}tap_{—}length_{—}minus1[ i ]
        for( j = 0; j <= hor_tap_length_minus1[ i ]; j++ )
          hor_{—}filter_{—}coeff[ i ][ j ]
      }
    }
  }
}
```

The SEI message of TAB3 signals one down-sampling process and one up-sampling process for the chroma components of decoded pictures. When the resampling processes signaled in the SEI message of TAB3 are used, for any number of up-sampling and down-sampling iterations performed on the decoded pictures, the degradation of the color components is expected to be minimized.

ver_chroma_filter_idc is a syntax element identifying the vertical components of the down-sampling and up-sampling sets of filters as specified in Table TAB4. Based on the value of ver_chroma_filter_idc, the values of verFiltCoeff[ ][ ] are derived from Table TAB5. The value of ver_chroma_filter_idc shall be in the range of “0” to “2”, inclusive. Values of ver_chroma_filter_idc greater than “2” are reserved for future use.

When ver_chroma_filter_idc is equal to “0”, the chroma resampling filter in the vertical direction is unspecified.

When chroma_format_idc is equal to “1”, ver_chroma_filter_idc shall be equal to “1” or “2”.

TABLE TAB4

| Value | Description |
|---|---|
| 0 | Unspecified |
| 1 | Filters signaled by hor_filter_coeff[ ][ ] |
| 2 | Filters as described in the 5/3 filter |
| | description of Rec. ITU-T T.800 \| ISO/IEC |
| | 15444-1 |
| >2 | Reserved |

TABLE TAB5

| | ver_filtering_ | | | |
|---|---|---|---|---|
| chromaSampleLocType | field_processing_fl | upsamplingFlag | verFilterCoeff[ ][ ] | verTapLength[ ] |
| 0, 1 | 0 | 0 | verFilterCoeff[ 0 ][ ] = { −3, −19, 34, | verTapLength[ 0 ] = 8 |
| | | | 500, 500, 34, −19, −3 } | |
| | | 1 | verFilterCoeff[ 1 ][ ] = { 19, 103, | verTapLength[ 1 ] = 4 |
| | | | 1037, −135 } | |
| | 1 | 0 | verFilterCoeff[ 0 ][ ] = { −8, −26, | verTapLength[ 0 ] = 8 |
| | | | 115, 586, 409, −48, −4, 0 } | |
| | | 1 | verFilterCoeff[ 1 ][ ] = { 24, −41, | verTapLength[ 1 ] = 4 |
| | | | 1169, −128 } | |
| | | | verFilterCoeff[ 2 ][ ] = { −76, 783, | verTapLength[ 2 ] = 4 |
| | | | 330, −13 } | |

hor_chroma_filter_idc is a syntax element identifying the horizontal components of the down-sampling and up-sampling sets of filters as specified in Table TAB6. Based on the value of hor_chroma_filter_idc, the values of horFilterCoeff[ ] [ ] are derived from Table TAB7. The value of hor_chroma_filter_idc shall be in the range of “0” to “2”, inclusive. Values of hor_chroma_filter_idc greater than “2” are reserved for future use.

When hor_chroma_filter_idc is equal to “0”, the chroma resampling filter in the horizontal direction is unspecified.

When chroma_format_idc is equal to “3”, hor_chroma_filter_idc shall be equal to “1” or “2”.

When chroma_format_idc is equal to “2” and ver_chroma_filter_idc is equal to “2”, hor_chroma_filter_idc shall be equal to “0”.

It is a requirement of bitstream conformance that ver_chroma_filter_idc and hor_chroma_filter_idc shall not be both equal to “0”.

TABLE TAB6

| Value | Description |
|---|---|
| 0 | Unspecified |
| 1 | Filters signaled by hor_filter_coeff[ ][ ] |
| 2 | Filters as described in the 5/3 filter |
| | description of Rec. ITU-T T.800 \| ISO/IEC |
| | 15444-1 |
| >2 | Reserved |

TABLE TAB7

| | ver_filtering_field_ | | | |
|---|---|---|---|---|
| chromaSampleLocType | processing_flag | upsamplingFlag | verFilterCoeff[ ][ ] | verTapLength[ ] |
| 0, 1 | 0 | 0 | verFilterCoeff[ 0 ][ ] = { −3, −19, | verTapLength[ 0 ] = |
| | | | 34, 500, 500, 34, −19, −3 } | 8 |
| | | 1 | verFilterCoeff[ 1 ][ ] = { 19, 103, | verTapLength[ 1 ] = |
| | | | 1037, −135 } | 4 |
| | 1 | 0 | verFilterCoeff[ 0 ][ ] = { −8, −26, | verTapLength[ 0 ] = |
| | | | 115, 586, 409, −48, −4, 0 } | 8 |
| | | 1 | verFilterCoeff[ 1 ][ ] = { 24, −41, | verTapLength[ 1 ] = |
| | | | 1169, −128 } | 4 |
| | | | verFilterCoeff[ 2 ][ ] = { −76, 783, | verTapLength[ 2 ] = |
| | | | 330, −13 } | 4 |

The SEI message of TAB3 suffers of the same limitations as the SEI message of TAB1. In addition, it applies only to the chroma.

After the quantization step 309, the current block is reconstructed so that the pixels corresponding to that block can be used for future predictions. This reconstruction phase is also referred to as a prediction loop. An inverse quantization is therefore applied to the transformed and quantized residual block during a step 312 and an inverse transformation is applied during a step 313. According to the prediction mode used for the block obtained during a step 314, the prediction block of the block is reconstructed. If the current block is encoded according to an inter prediction mode, the encoding module applies, when appropriate, during a step 316, a motion compensation using the motion vector of the current block in order to identify the reference block of the current block. If the current block is encoded according to an intra prediction mode, during a step 315, the prediction direction corresponding to the current block is used for reconstructing the prediction block of the current block. The prediction block and the reconstructed residual block are added in order to obtain the reconstructed current block.

Following the reconstruction, an in-loop filtering intended to reduce the encoding artefacts is applied, during a step 317, to the reconstructed block. This filtering is called in-loop filtering since this filtering occurs in the prediction loop to obtain at the decoder the same reference pictures as the encoder and thus avoid a drift between the encoding and the decoding processes. In-loop filtering tools comprises deblocking filtering, SAO (Sample adaptive Offset) and ALF (Adaptive Loop Filtering).

When a block is reconstructed, it is inserted during a step 318 into a reconstructed picture stored in a memory 319 of reconstructed pictures generally called Decoded Picture Buffer (DPB). The reconstructed pictures thus stored can then serve as reference pictures for other pictures to be coded.

When RPR is activated, samples from (i.e. at least a portion of) pictures stored in the DPB are resampled in a step 320 when used for motion estimation and compensation. The resampling step 320 and motion compensation step 316 can be combined in one single sample interpolation step. Note that the motion estimation step (304), which actually uses motion compensation, would, in this case also, use the single sample interpolation step.

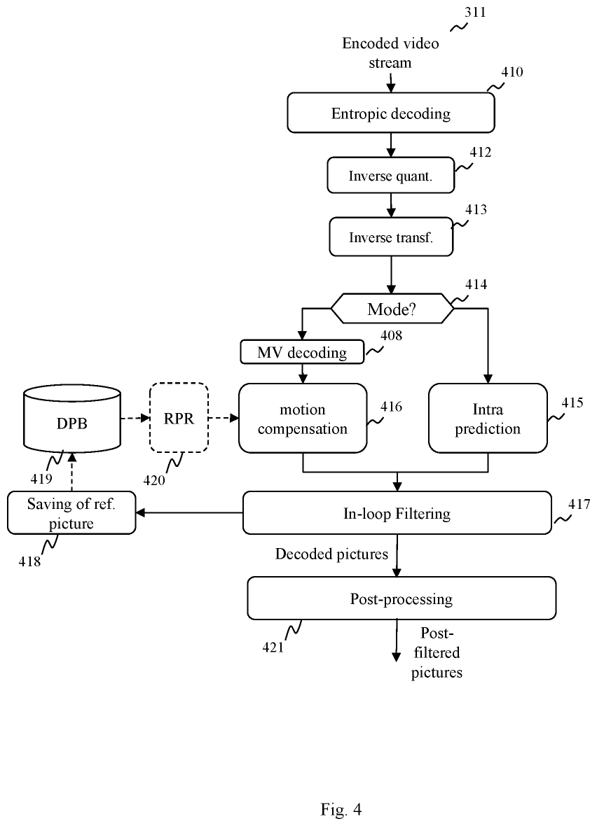

FIG. 4 depicts schematically a method for decoding the encoded video stream 311 encoded according to method described in relation to FIG. 3 executed by a decoding module. Variations of this method for decoding are contemplated, but the method for decoding of FIG. 4 is described below for purposes of clarity without describing all expected variations.

The decoding is done block by block. For a current block, it starts with an entropic decoding of the current block during a step 410. Entropic decoding allows to obtain the prediction mode of the block.

If the block has been encoded according to an inter prediction mode, the entropic decoding allows to obtain, when appropriate, a prediction vector index, a motion residual and a residual block. During a step 408, a motion vector is reconstructed for the current block using the prediction vector index and the motion residual.

If the block has been encoded according to an intra prediction mode, entropic decoding allows to obtain a prediction direction and a residual block. Steps 412, 413, 414, 415, 416 and 417 implemented by the decoding module are in all respects identical respectively to steps 412, 413, 414, 415, 416 and 417 implemented by the encoding module. Decoded blocks are saved in decoded pictures and the decoded pictures are stored in a DPB 419 in a step 418. When the decoding module decodes a given picture, the pictures stored in the DPB 419 are identical to the pictures stored in the DPB 319 by the encoding module during the encoding of said given image. The decoded picture can also be outputted by the decoding module for instance to be displayed. When RPR is activated, samples of (i.e. at least a portion of) the picture used as reference pictures are resampled in step 420 to the resolution of the predicted picture. The resampling step (420) and motion compensation step (416) can be combined in one single sample interpolation step.

Since displaying a video sequence with heterogeneous picture resolutions would be unacceptable for a user, when RPR is used, a resampling is applied in a post processing step 421 on the reconstructed picture to homogenize their resolutions.

As already mentioned above, one issue with the post-filtering SEI messages defined until now (and described in relation to tables TAB1 and TAB3) is that these SEI messages are not adapted to video sequence comprising pictures encoded at different resolutions. In the following, new SEI messages are proposed to deal with this issue.

The post-processing step 421 can also comprise an inverse color transform (e.g. conversion from YCbCr 4:2:0 to RGB 4:4:4), an inverse mapping performing the inverse of the remapping process performed in the pre-processing of step 301 and a post-filtering for improving the reconstructed pictures based for example on filter parameters provided in a SEI message.

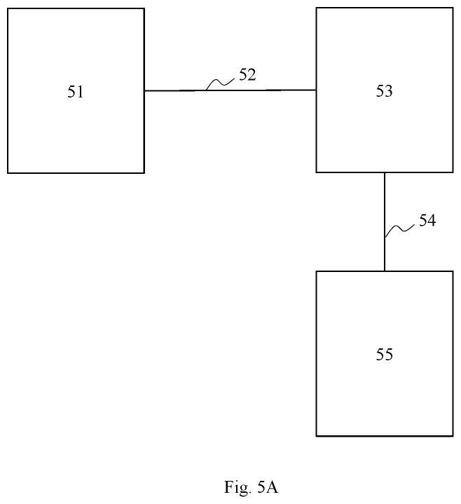

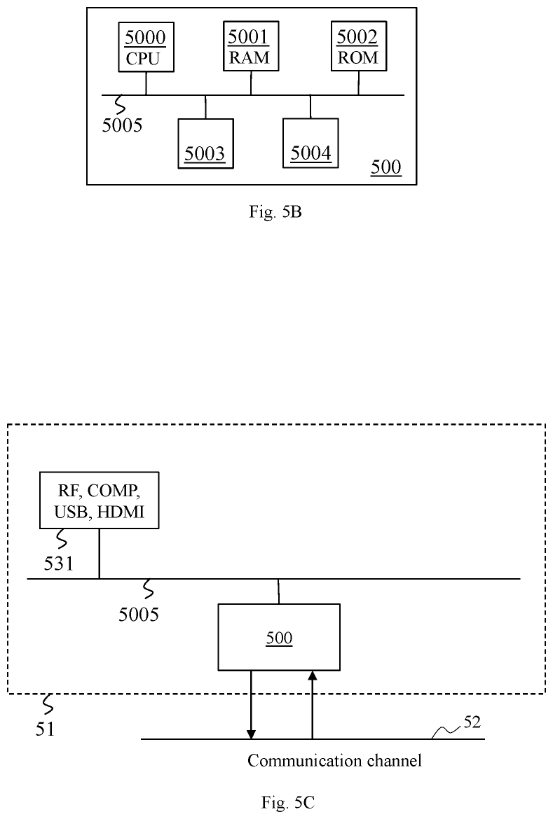

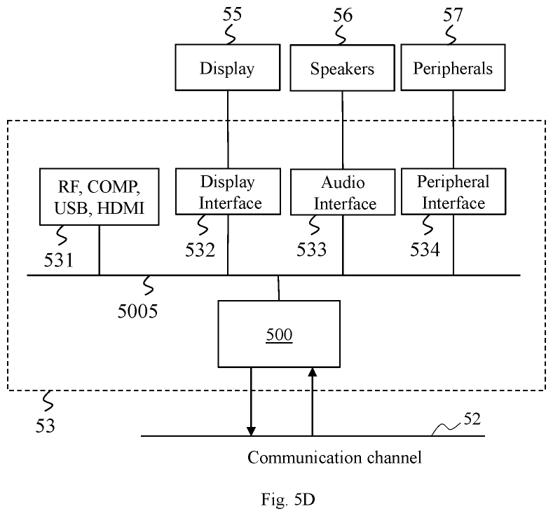

FIG. 5A describes an example of a context in which following embodiments can be implemented.

In FIG. 4A, an apparatus 51, that could be a camera, a storage device, a computer, a server or any device capable of delivering a video stream, transmits a video stream to a system 53 using a communication channel 52. The video stream is either encoded and transmitted by the apparatus 51 or received and/or stored by the apparatus 51 and then transmitted. The communication channel 52 is a wired (for example Internet or Ethernet) or a wireless (for example WiFi, 3G, 4G or 5G) network link.

The system 53, that could be for example a set top box, receives and decodes the video stream to generate a sequence of decoded pictures.

The obtained sequence of decoded pictures is then transmitted to a display system 55 using a communication channel 54, that could be a wired or wireless network. The display system 55 then displays said pictures.

In an embodiment, the system 53 is comprised in the display system 55. In that case, the system 53 and display 55 are comprised in a TV, a computer, a tablet, a smartphone, a head-mounted display, etc.

FIG. 5B illustrates schematically an example of hardware architecture of a processing module 500 able to implement an encoding module or a decoding module capable of implementing respectively a method for encoding of FIG. 3 and a method for decoding of FIG. 4 modified according to different aspects and embodiments. The encoding module is for example comprised in the apparatus 51 when this apparatus is in charge of encoding the video stream. The decoding module is for example comprised in the system 53. The processing module 500 comprises, connected by a communication bus 5005: a processor or CPU (central processing unit) 5000 encompassing one or more microprocessors, general purpose computers, special purpose computers, and processors based on a multi-core architecture, as non-limiting examples; a random access memory (RAM) 5001; a read only memory (ROM) 5002; a storage unit 5003, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 5004 for exchanging data with other modules, devices or equipment. The communication interface 5004 can include, but is not limited to, a transceiver configured to transmit and to receive data over a communication channel. The communication interface 5004 can include, but is not limited to, a modem or network card.

If the processing module 500 implements a decoding module, the communication interface 5004 enables for instance the processing module 500 to receive encoded video streams and to provide a sequence of decoded pictures. If the processing module 500 implements an encoding module, the communication interface 5004 enables for instance the processing module 500 to receive a sequence of original picture data to encode and to provide an encoded video stream.

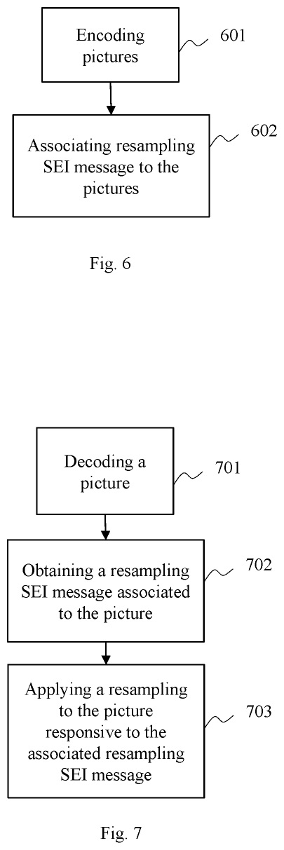

The processor 5000 is capable of executing instructions loaded into the RAM 5001 from the ROM 5002, from an external memory (not shown), from a storage medium, or from a communication network. When the processing module 500 is powered up, the processor 5000 is capable of reading instructions from the RAM 5001 and executing them. These instructions form a computer program causing, for example, the implementation by the processor 5000 of a decoding method as described in relation with FIG. 4, an encoding method described in relation to FIG. 3, and methods described in relation to FIG. 6 or 7, these methods comprising various aspects and embodiments described below in this document.

All or some of the algorithms and steps of the methods of FIGS. 3, 4, 6 and 7 may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

As can be seen, microprocessors, general purpose computers, special purpose computers, processors based or not on a multi-core architecture, DSP, microcontroller, FPGA and ASIC are electronic circuitry adapted to implement at least partially the methods of FIGS. 3, 4, 6 and 7.

FIG. 5D illustrates a block diagram of an example of the system 53 in which various aspects and embodiments are implemented. The system 53 can be embodied as a device including the various components described below and is configured to perform one or more of the aspects and embodiments described in this document. Examples of such devices include, but are not limited to, various electronic devices such as personal computers, laptop computers, smartphones, tablet computers, digital multimedia set top boxes, digital television receivers, personal video recording systems, connected home appliances and head mounted display. Elements of system 53, singly or in combination, can be embodied in a single integrated circuit (IC), multiple ICs, and/or discrete components. For example, in at least one embodiment, the system 53 comprises one processing module 500 that implements a decoding module. In various embodiments, the system 53 is communicatively coupled to one or more other systems, or other electronic devices, via, for example, a communications bus or through dedicated input and/or output ports. In various embodiments, the system 53 is configured to implement one or more of the aspects described in this document.

The input to the processing module 500 can be provided through various input modules as indicated in block 531. Such input modules include, but are not limited to, (i) a radio frequency (RF) module that receives an RF signal transmitted, for example, over the air by a broadcaster, (ii) a component (COMP)input module (or a set of COMP input modules), (iii) a Universal Serial Bus (USB) input module, and/or (iv) a High Definition Multimedia Interface (HDMI) input module. Other examples, not shown in FIG. 5D, include composite video.

In various embodiments, the input modules of block 531 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system 53 to other electronic devices across USB and/or HDMI connections. It is to be understood that various aspects of input processing, for example, Reed-Solomon error correction, can be implemented, for example, within a separate input processing IC or within the processing module 500 as necessary. Similarly, aspects of USB or HDMI interface processing can be implemented within separate interface ICs or within the processing module 500 as necessary. The demodulated, error corrected, and demultiplexed stream is provided to the processing module 500.

Various elements of system 53 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 53, the processing module 500 is interconnected to other elements of said system 53 by the bus 5005.

The communication interface 5004 of the processing module 500 allows the system 53 to communicate on the communication channel 52. As already mentioned above, the communication channel 52 can be implemented, for example, within a wired and/or a wireless medium.

Data is streamed, or otherwise provided, to the system 53, in various embodiments, using a wireless network such as a Wi-Fi network, for example IEEE 802.11 (IEEE refers to the Institute of Electrical and Electronics Engineers). The Wi-Fi signal of these embodiments is received over the communications channel 52 and the communications interface 5004 which are adapted for Wi-Fi communications. The communications channel 52 of these embodiments is typically connected to an access point or router that provides access to external networks including the Internet for allowing streaming applications and other over-the-top communications. Other embodiments provide streamed data to the system 53 using the RF connection of the input block 531. As indicated above, various embodiments provide data in a non-streaming manner. Additionally, various embodiments use wireless networks other than Wi-Fi, for example a cellular network or a Bluetooth network.

The system 53 can provide an output signal to various output devices, including the display system 55, speakers 56, and other peripheral devices 57. The display system 55 of various embodiments includes one or more of, for example, a touchscreen display, an organic light-emitting diode (OLED) display, a curved display, and/or a foldable display. The display 55 can be for a television, a tablet, a laptop, a cell phone (mobile phone), a head mounted display or other devices. The display system 55 can also be integrated with other components (for example, as in a smart phone), or separate (for example, an external monitor for a laptop). The other peripheral devices 57 include, in various examples of embodiments, one or more of a stand-alone digital video disc (or digital versatile disc) (DVR, for both terms), a disk player, a stereo system, and/or a lighting system. Various embodiments use one or more peripheral devices 57 that provide a function based on the output of the system 53. For example, a disk player performs the function of playing an output of the system 53.

In various embodiments, control signals are communicated between the system 53 and the display system 55, speakers 56, or other peripheral devices 57 using signaling such as AV.Link, Consumer Electronics Control (CEC), or other communications protocols that enable device-to-device control with or without user intervention. The output devices can be communicatively coupled to system 53 via dedicated connections through respective interfaces 532, 533, and 534. Alternatively, the output devices can be connected to system 53 using the communications channel 52 via the communications interface 5004 or a dedicated communication channel corresponding to the communication channel 54 in FIG. 5A via the communication interface 5004. The display system 55 and speakers 56 can be integrated in a single unit with the other components of system 53 in an electronic device such as, for example, a television. In various embodiments, the display interface 532 includes a display driver, such as, for example, a timing controller (T Con) chip.

The display system 55 and speaker 56 can alternatively be separate from one or more of the other components. In various embodiments in which the display system 55 and speakers 56 are external components, the output signal can be provided via dedicated output connections, including, for example, HDMI ports, USB ports, or COMP outputs.

FIG. 5C illustrates a block diagram of an example of the system 51 in which various aspects and embodiments are implemented. System 51 is very similar to system 53. The system 51 can be embodied as a device including the various components described below and is configured to perform one or more of the aspects and embodiments described in this document. Examples of such devices include, but are not limited to, various electronic devices such as personal computers, laptop computers, smartphones, tablet computers, a camera and a server. Elements of system 51, singly or in combination, can be embodied in a single integrated circuit (IC), multiple ICs, and/or discrete components. For example, in at least one embodiment, the system51 comprises one processing module 500 that implements an encoding module. In various embodiments, the system 51 is communicatively coupled to one or more other systems, or other electronic devices, via, for example, a communications bus or through dedicated input and/or output ports. In various embodiments, the system 51 is configured to implement one or more of the aspects described in this document.

The input to the processing module 500 can be provided through various input modules as indicated in block 531 already described in relation to FIG. 5D.

Various elements of system 51 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 51, the processing module 500 is interconnected to other elements of said system 51 by the bus 5005.

The communication interface 5004 of the processing module 500 allows the system 500 to communicate on the communication channel 52.

Data is streamed, or otherwise provided, to the system 51, in various embodiments, using a wireless network such as a Wi-Fi network, for example IEEE 802.11 (IEEE refers to the Institute of Electrical and Electronics Engineers). The Wi-Fi signal of these embodiments is received over the communications channel 52 and the communications interface 5004 which are adapted for Wi-Fi communications. The communications channel 52 of these embodiments is typically connected to an access point or router that provides access to external networks including the Internet for allowing streaming applications and other over-the-top communications. Other embodiments provide streamed data to the system 51 using the RF connection of the input block 531.

As indicated above, various embodiments provide data in a non-streaming manner. Additionally, various embodiments use wireless networks other than Wi-Fi, for example a cellular network or a Bluetooth network.

The data provided to the system 51 can be provided in different format. In various embodiments these data are encoded and compliant with a known video compression format such as AV1, VP9, VVC, HEVC, AVC, SVC, SHVC, etc. In various embodiments, these data are raw data provided by a picture and/or audio acquisition module connected to the system 51 or comprised in the system 51. In that case, the processing module take in charge the encoding of these data.

The system 51 can provide an output signal to various output devices capable of storing and/or decoding the output signal such as the system 53.

Various implementations involve decoding. “Decoding”, as used in this application, can encompass all or part of the processes performed, for example, on a received encoded video stream in order to produce a final output suitable for display. In various embodiments, such processes include one or more of the processes typically performed by a decoder, for example, entropy decoding, inverse quantization, inverse transformation, and prediction. In various embodiments, such processes also, or alternatively, include processes performed by a decoder of various implementations described in this application, for example, for decoding pictures of different resolutions from an encoded video stream, for decoding a SEI message comprising post-filtering information and for resampling pictures responsive to the post-filtering information.

Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded video stream. In various embodiments, such processes include one or more of the processes typically performed by an encoder, for example, partitioning, prediction, transformation, quantization, and entropy encoding. In various embodiments, such processes also, or alternatively, include processes performed by an encoder of various implementations described in this application, for example, for generating an encoded video stream comprising pictures of different resolutions and for associating a SEI message comprising post-filtering information.

Whether the phrase “encoding process” is intended to refer specifically to a subset of operations or generally to the broader encoding process will be clear based on the context of the specific descriptions and is believed to be well understood by those skilled in the art.

Note that the syntax elements names as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between a rate and a distortion is usually considered. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of a reconstructed signal after coding and decoding. Faster approaches may also be used, to save encoding complexity, in particular with computation of an approximated distortion based on a prediction or a prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a use of some coding tools. In this way, in an embodiment the same parameters can be used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the encoded video stream and SEI messages of a described embodiment. Such a signal can be formatted, for example, as an electromagnetic wave (for example, using a radio frequency portion of spectrum) or as a baseband signal. The formatting can include, for example, encoding an encoded video stream and modulating a carrier with the encoded video stream. The information that the signal carries can be, for example, analog or digital information. The signal can be transmitted over a variety of different wired or wireless links, as is known. The signal can be stored on a processor-readable medium.

In the following, various embodiments propose two new SEI messages better suited for video sequences comprising pictures having heterogeneous picture resolutions. The proposed SEI messages differ from the SEI message of tables TAB1 and TAB3 in that:
they provide filters for resampling improvement rather than for subjective quality improvement. The two new SEI messages could be used jointly or separately to improve both aspects;
they allow signaling various types of filters such as for example, Neural Networks (NN) based resampling filters;
they can apply to all pictures or only to a subset of pictures that need to be resampled;
they can apply for a certain duration and can be replaced by successive SEI messages with different parameters, rather than apply at the sequence level;
they can apply to both luma and chroma.

Table TAB8 describes a first embodiment of a new SEI message, called resampling SEI message, better adapted to video sequences comprising pictures having heterogeneous picture resolutions.

```
TABLE TAB8
resampling( payloadSize ) {
  resampling_id
  resampling_cancel_flag
  if( !resampling_cancel_flag ) {
    resampling_persistence_flag
    num_resampling_filters_luma_hor
    for( i = 0; i < num_resampling_filters_luma_hor; i++ ) {
            resampling_tap_luma_hor_minus1[ i ]
            for( j = 0; j <= resampling_tap_luma_hor_minus1;
            j++ ) {
                resampling_luma_hor_coeff[ i ][ j ]
                }
        }
    use_alternative_filter_for_vertical_luma
    if( use_alternative_filter_for_vertical_luma ) {
          num_resampling_filters_luma_ver
          for( i = 0; i < num_resampling_filters_luma_ver; i++ ) {
                resampling_tap_luma_ver_minus1[ i ]
                  for( j = 0; j <=
                  resampling_tap_luma_ver_minus1; j++ ) {
                    resampling_luma_ver_coeff[ i ][ j ]
                  }
              }
        }
  use_alternative_filter_for_chroma
  if( use_alternative_filter_for_chroma ) {
    num_resampling_filters_chroma_hor
    for( i = 0; i < num_resampling_filters_chroma_hor; i++ ) {
            resampling_tap_chroma_hor_minus1[ i ]
            for( j = 0; j <= resampling_tap_chroma_hor_minus1;
            j++ ) {
                  resampling_chroma_hor_coeff[ i ][ j ]
          }
      }
        use_alternative_filter_for_vertical_chroma
        if( use_alternative_filter_for_vertical_chroma ) {
            num_resampling_filters_chroma_ver
            for( i = 0; i < num_resampling_filters_chroma_ver;
            i++ ) {
                  resampling_tap_chroma_ver_minus1[ i ]
                  for( i = 0; i <=
                  resampling_tap_chroma_ver_minus1; i++ ) {
                      resampling_chroma_ver_coeff[ i ][ j ]
                      }
                  }
            }
      }
  }
}
```

resampling_id is an identifier that is used to identify the purpose of the resampling information. The value of resampling_id shall be in the range of “0” to 2³¹−2, inclusive.

The syntax element resampling_cancel_flag equal to “1” indicates that the resampling SEI message cancels the persistence of any previous resampling SEI message in output order that applies to a current layer as defined for instance in VVC. resampling_cancel_flag equal to “0” indicates that resampling information follows.

The syntax element resampling_persistence_flag specifies the persistence of the resampling SEI message. resampling_persistence_flag equal to “0” specifies that the resampling information applies to the current decoded picture only. Let picA be the current picture. resampling_persistence_flag equal to “1” specifies that the resampling information persists for the current layer in output order until any of the following conditions are true:
A new CLVS (coded layer video sequence as defined for instance in VVC) of the current layer begins.
A picture picB in the current layer with a picture order count (i.e. picture number in decoding order) greater than the picture order count of the picture picA in an access unit containing a resampling SEI message with the same value of resampling_id.

The syntax element resampling_tap_luma_hor_minus1 specifies the size of the filter coefficients array that is applied to pictures to be resampled. The value of resampling_tap_luma_hor_minus1 shall be in the range of “1” to “15”, inclusive.

The syntax element resampling_luma_hor_coeff[i] specifies a filter coefficient for luma component with 16-bit precision that is applied to pictures to be resampled. The value of resampling_luma_hor_coeff[i] shall be in the range of −2³¹+1 to 2³¹−1.

The syntax element use_alternative_filter_for_vertical_luma specifies if resampling information for vertical filtering for luma component is different from horizontal luma information.

The syntax element num_resampling_filters_luma_hor specifies a number of filters signaled for luma resampling in the horizontal direction.

The syntax element resampling_tap_luma_ver_minus1 specifies the size of the filter coefficients array that is applied to pictures to be resampled. The value of resampling_tap_luma_ver_minus1 shall be in the range of “1” to “15”, inclusive.

The syntax element resampling_luma_ver_coeff[i] specifies a filter coefficient for luma component with 16-bit precision that is applied to pictures to be resampled. The value of resampling_luma_ver_coeff[i] shall be in the range of −2³¹+1 to 2³¹−1.

The syntax element use_alternative_filter_for_chroma specifies if resampling information is coded for chroma.

It is a requirement of bitstream conformance that when use_alternative_filter_for_chroma is equal to “1”, sps_chroma_format_idc (which specifies the chroma sampling relative to the luma sampling) shall not be equal to “0” representing a monochrome sequence.

The syntax element num_resampling_filters_chroma_hor specifies the number of filters signaled for chroma resampling in the horizontal direction.

The syntax element resampling_tap_chroma_hor_minus1 specifies the size of the filter coefficients array that is applied to pictures to be resampled. The value of resampling_tap_chroma_minus1 shall be in the range of “1” to “15”, inclusive.

The syntax element resampling_chroma_hor_coeff[i] specifies a filter coefficient for chroma component with 16-bit precision that is applied to pictures to be resampled. The value of resampling_chroma_coeff[i] shall be in the range of −2³¹+1 to 2³¹−1.

The syntax element use_alternative_filter_for_vertical_chroma specifies if resampling information for vertical filtering for chroma component is different from horizontal chroma information.

The syntax element resampling_tap_chroma_ver_minus1 specifies the size of the filter coefficients array that is applied to pictures to be resampled. The value of resampling_tap_chroma_ver_minus1 shall be in the range of “1” to “15”, inclusive.

resampling_chroma_ver_coeff[i] specifies a filter coefficient for chroma component with 16-bit precision that is applied to pictures to be resampled. The value of resampling_chroma_ver_coeff[i] shall be in the range of −2³¹+1 to 2³¹−1.

The resampling SEI message enables the description of both luma and chroma resampling coefficients. The resampling SEI message is particularly adapted to the case of video sequences encoded using the RPR tool. Indeed, these sequences are mainly constituted of pictures at an original resolution and pictures at a reduced resolution. In that case, the resampling consists in an up-sampling of the pictures at the reduced resolution to their original resolution. However, the applications of the resampling SEI message is not limited to the up-sampling, the resampling SEI message being adapted to specify a down-sampling filter but also any filter, such as a filter adapted to improve a subjective quality of pictures.

In some embodiments, the resampling SEI message is used in combination with any post-filter SEI message (such the SEI messages of tables TAB1 and TAB3), resampling being applied before the post-filtering.

In a first variant of the first embodiment, the semantics of the resampling SEI message is changed to only apply to pictures that are not at the same resolution than a maximum resolution, so when pps_pic_width_in_luma_samples (which specifies the width of each decoded picture referring to a Picture Parameter Set (PPS) (i.e. a picture header) in units of luma samples) is not equal to sps_pic_width_max_in_luma_samples (which specifies the maximum width, in units of luma samples, of each decoded picture referring to a Sequence Parameter Set (SPS) (i.e. a sequence header)) and pps_pic_height_in_luma_samples (which specifies the height of each decoded picture referring to a PPS) is not equal to sps_pic_height_max_in_luma_samples (which specifies the maximum height, in units of luma samples, of each decoded picture referring to a SPS).

In a second variant of the first embodiment, the syntax of the resampling SEI message is modified to check whether the current picture is at a lower resolution than the maximum resolution in the sequence. The second variant is represented in table TAB9, the difference between table TAB9 and table TAB8 being represented in bold.

```
TABLE TAB9
resampling( payloadSize ) {
  resampling_id
  resampling_cancel_flag
  if( !resampling_cancel_flag ) {
    resampling_persistence_flag
  if (pps_{—}pic_{—}width_{—}in_{—}luma_{—}samples !=
sps_{—}pic_{—}width_{—}max_{—}in_{—}luma_{—}samples ∥
pps_{—}pic_{—}height_{—}in_{—}luma_{—}samples !
=sps_{—}pic_{—}height_{—}max_{—}in_{—}luma_{—}samples)
    num_resampling_filters_luma_hor
    for( i = 0; i < num_resampling_filters_luma_hor; i++ ) {
        resampling_tap_luma_hor_minus1[ i ]
        for( j = 0; j <= resampling_tap_luma_hor_minus1; j++ ) {
          resampling_luma_hor_coeff[ i ][ j ]
          }
      }
... ...
```

In a second embodiment, a second SEI message called resampling method SEI message, represented in table TAB10, is proposed. In the resampling method SEI message, an index is coded to signal an existing resampling filter, the characteristics of which are known by the encoding module and the decoding module.

TABLE TAB10

```
resampling_method( payloadSize ) {
  resampling_method_hor_luma
  if( resampling_method_hor_luma < 3 ) {
    use_alternative_filter_for_vertical_luma
    if( use_alternative_filter_for_vertical_luma ) {
        resampling_method_ver_luma
    }
  }
  resampling_method_hor_chroma
  if( resampling_method_hor_chroma < 3 ) {
    use_alternative_filter_for_chroma
    if( use_alternative_filter_for_chroma ) {
        resampling_method_ver_chroma
      }
    }
}
```

The syntax element resampling_method_hor_luma identifies the resampling method used for horizontal filtering of luma component as specified in Table TAB11. The value of resampling_method_luma shall be in the range of “0” to “6”, inclusive. Values “7” to “15” are reserved for future use.

The syntax element use_alternative_filter_for_vertical_luma specifies if resampling information for vertical filtering of luma component is different from the resampling information for horizontal filtering of luma component.

As method “3” to “6” in table TAB11 are not separable, we don't need to code use_alternative_filter_for_vertical_luma(respectively use_alternative_filter_for_vertical_chroma) if resampling_method_hor_luma(respectively resampling_method_hor_chroma) is greater or equal to “3”.

The syntax element resampling_method_ver_luma identifies the resampling method used for vertical filtering for luma component as specified in Table TAB11. The value of resampling_method_luma shall be in the range of “0” to “6”, inclusive. Values “7” to “15” are reserved for future use.

The syntax element resampling_method_hor_chroma identifies the resampling method used for horizontal filtering for chroma component as specified in Table TAB11. The value of resampling_method_chroma shall be in the range of “0” to “6”, inclusive. Values “7” to “15” are reserved for future use.

The syntax element use_alternative_filter_for_vertical_chroma specifies if resampling information for vertical filtering of chroma component is different from resampling information for vertical filtering of luma component.

TABLE TAB11

| resampling_ | |
|---|---|
| method | |
| value | Associated resampling method |
| 0 | Luma filter |
| 1 | Chroma filter |
| 2 | Bilinear filter |
| 3 | DCC (Directional Cubic Convolution Interpolation)Error! |
| | Reference source not found. |
| 4 | ICBI (Iterative Curvature-based Interpolation)Error! |
| | Reference source not found. |
| 5 | EGII (Edge-Guided Image Interpolation) Error! Reference |
| | source not found. |
| 6 | Deep learning based filter |
| 7 . . . 15 | Reserved |

In a variant, this resampling method SEI message is only applied if sps_ref_pic_resampling_enabled_flag or sps_res_change_in_clvs_allowed_flag are equal to “1”. sps_ref_pic_resampling_enabled_flag equal to “1” specifies that RPR is enabled. sps_ref_pic_resampling_enabled_flag equal to “0” specifies that RPR is disabled. sps_res_change_in_clvs_allowed_flag equal to “1” specifies that the picture spatial resolution might change within a CLVS referring to the SPS. sps_res_change_in_clvs_allowed_flag equal to “0” specifies that the picture spatial resolution does not change within any CLVS referring to the SPS.

In an embodiment, the resampling method SEI message is used in combination with a variant of the resampling SEI message. The variant of the resampling SEI message corresponding to this embodiment is described in table TAB12:

```
TABLE TAB12
resampling( payloadSize ) {
  resampling_id
  resampling_cancel_flag
  if( !resampling_cancel_flag ) {
    resampling_persistence_flag
    use_{—}resampling_{—}method_{—}SEI
      num_resampling_filters_luma_hor
      for( i = 0; i < num_resampling_filters_luma_hor; i++ ) {
            resampling_tap_luma_hor_minus1[ i ]
            for( j = 0; j <= resampling_tap_luma_hor_minus1;
            j++ ) {
                resampling_luma_hor_coeff[ i ][ j ]
                }
        }
      use_alternative_filter_for_vertical_luma
      if( use_alternative_filter_for_vertical_luma ) {
          num_resampling_filters_luma_ver
          for( i = 0; i < num_resampling_filters_luma_ver;
          i++ ) {
                resampling_tap_luma_ver_minus1[ i ]
                  for( j = 0; j <=
                  resampling_tap_luma_ver_minus1; j++ ) {
                    resampling_luma_ver_coeff[ i ][ j ]
                  }
              }
        }
    use_alternative_filter_for_chroma
    if( use_alternative_filter_for_chroma ) {
      num_resampling_filters_chroma_hor
      for( i = 0; i < num_resampling_filters_chroma_hor; i++ ) {
            resampling_tap_chroma_hor_minus1[ i ]
              for( j = 0; j <= resampling_tap_chroma_hor_minus1;
              j++ ) {
                  resampling_chroma_hor_coeff[ i ][ j ]
          }
      }
        use_alternative_filter_for_vertical_chroma
        if( use_alternative_filter_for_vertical_chroma ) {
            num_resampling_filters_chroma_ver
            for( i = 0; i < num_resampling_filters_chroma_ver;
            i++ ) {
                  resampling_tap_chroma_ver_minus1[ i ]
                  for( i = 0; i <=
                  resampling_tap_chroma_ver_minus1; i++ ) {
                      resampling_chroma_ver_coeff[ i ][ j ]
                      }
                  }
            }
      }
    }
}
```

Differences between the resampling SEI messages of TAB8 and TAB12 are indicated in bold.

The syntax element use_resampling_method_SEI, indicates, when equal to “1” that, if at least one resampling method SEI message is present in the bitstream, the resampling method specified in the last received resampling method SEI message shall be used in place of the resampling filter specified in the resampling SEI message. If use_resampling_method_SEI is equal to zero, the resampling filter specified in the resampling SEI message is used.

In an embodiment, the resampling method SEI is independent of the resampling SEI message. In this embodiment, the resampling method SEI message can be viewed as an alternative to the resampling SEI message. This embodiment uses a variant of the resampling method SEI message described in table TAB13:

TABLE TAB13

```
resampling_method( payloadSize ) {
  resampling_{—}id
  resampling_{—}cancel_{—}flag
  if( !resampling_{—}cancel_{—}flag ) {
    resampling_{—}persistence_{—}flag
    resampling_method_hor_luma
    if( resampling_method_hor_luma < 3 ) {
      use_alternative_filter_for_vertical_luma
      if( use_alternative_filter_for_vertical_luma ) {
          resampling_method_ver_luma
      }
    }
    resampling_method_hor_chroma
    if( resampling_method_hor_chroma < 3 ) {
      use_alternative_filter_for_chroma
      if( use_alternative_filter_for_chroma ) {
          resampling_method_ver_chroma
        }
    }
  }
}
```

The differences between the resampling method SEI message of TAB10 and TAB13 are indicated in bold. As can be seen the syntax elements resampling_id, resampling_cancel_flag, and resampling_persistence_flag are introduced in the resampling method SEI message with the same semantic as described in relation to the resampling SEI message of table TAB8.

FIG. 6 illustrates schematically an example of a method for encoding pictures of a video sequence along with metadata allowing controlling a resampling of these pictures.

The method of FIG. 6 is for example implemented by the apparatus 51, and more precisely by the processing module 500 of the apparatus 51.

In an embodiment, the apparatus 51 receives a RAW video sequence from the input modules 531.

In a step 601, the processing module 500 of the apparatus 51 encodes a plurality of pictures of the RAW video sequence in a portion of a bitstream using for example the method of FIG. 3. In an embodiment, a sub-set of pictures of the plurality was down-sampled (respectively up-sampled) before encoding in step 301.

In a step 602, the processing module 500 of the apparatus 51 encodes at least one resampling SEI message and/or at least one resampling method SEI message (i.e. metadata representative of a filter) in the bitstream. As described above, the resampling SEI message (or the resampling method SEI message of table TAB13) comprises at least one syntax element (i.e. resampling_cancel_flag, resampling_persistence_flag) specifying a subset of the plurality of pictures on which the filter specified by the SEI message is to be applied. For example, the processing module 500 of the apparatus 51 encodes in the bitstream a resampling SEI message (or a resampling method SEI message of TAB13) for each picture that needs to be resampled on the decoder side, each resampling SEI message (respectively each resampling method SEI message of TAB13) comprising a resampling_persistence_flag equal to zero.

FIG. 7 represents schematically an example of a method for reconstructing pictures comprising a resampling of pictures responsive to a resampling SEI message and/or a resampling method SEI message.

The method of FIG. 7 is for example implemented by the system 53, and more precisely by the processing module 500 of the system 53.

In a step 701, the processing module 500 of the system 53 decodes a current picture of a plurality of pictures representing a video sequence from a portion of a bitstream. For example, the current picture was down-sampled (respectively up-sampled) before its encoding.

In a step 702, the processing module 500 of the system 53 obtains parameters of a filter determined from at least one resampling SEI message and/or at least one resampling method SEI message embedded in the bitstream. As already mentioned, the resampling SEI message (or the resampling method SEI message of table TAB13) comprises at least one syntax element (i.e. resampling_cancel_flag, resampling_persistence_flag) specifying a subset of the plurality of pictures on which the filter specified by the SEI message is to be applied. For example, the bitstream comprises a resampling SEI message (or a resampling method SEI message of TAB13) associated to the current picture (i.e. comprising a resampling_persistence_flag equal to zero). The filter is for example an up-sampling (respectively down-sampling) filter allowing resampling the current picture at its original resolution.

In a step 703, the processing module 500 of the system 53 applies the filter on the decoded current picture responsive to the resampling SEI message (and/or the resampling method SEI message).

We described above a number of embodiments. Features of these embodiments can be provided alone or in any combination. Further, embodiments can include one or more of the following features, devices, or aspects, alone or in any combination, across various claim categories and types:
A bitstream or signal that includes one or more of the described syntax elements, or variations thereof.
Creating and/or transmitting and/or receiving and/or decoding a bitstream or signal that includes one or more of the described syntax elements, or variations thereof.
A TV, set-top box, cell phone, tablet, or other electronic device that performs at least one of the embodiments described.
A TV, set-top box, cell phone, tablet, or other electronic device that performs at least one of the embodiments described, and that displays (e.g. using a monitor, screen, or other type of display) a resulting picture.
A TV, set-top box, cell phone, tablet, or other electronic device that tunes (e.g. using a tuner) a channel to receive a signal including an encoded video stream, and performs at least one of the embodiments described.
A TV, set-top box, cell phone, tablet, or other electronic device that receives (e.g. using an antenna) a signal over the air that includes an encoded video stream, and performs at least one of the embodiments described.
A server, camera, cell phone, tablet or other electronic device that transmits (e.g. using an antenna) a signal over the air that includes an encoded video stream, and performs at least one of the embodiments described.
A server, camera, cell phone, tablet or other electronic device that tunes (e.g. using a tuner) a channel to transmit a signal including an encoded video stream, and performs at least one of the embodiments described.

1. A method comprising:
decoding a picture of a plurality of pictures representing a video sequence from video data;
obtaining parameters of a filter determined from an information set associated to the video data, the information set comprising at least one first information specifying a condition to apply the filter based on a second information representing a dimension of the picture; and
applying the filter on the decoded picture responsive to the information set.

2. The method according to claim 1 wherein the filter is a resampling filter.

3. The method according to claim 1 wherein the filter is a separable filter and the parameters obtained from the information set specifies parameters of a horizontal filter and parameters of a vertical filter.

4. The method according to claim 1 wherein the filter is intended to be applied to luma and chroma components of each picture of the subset of pictures and the parameters obtained from the information set specifies parameters of the filter adapted for the filtering of the luma component and parameters of the filter adapted for the filtering of the chroma components different from the parameters of the filter adapted for the filtering of the luma components.

5. The method of claim 1 wherein the at least one first information specifies that the filter is applied only to pictures that have a resolution different from a maximum resolution specified for the video sequence by a high-level syntax element.

6. The method of claim 1 wherein the information set comprises a third information specifying a filtering method in a plurality of filtering methods.

7. The method of claim 6 wherein the plurality of filtering methods comprises a luma filtering, a chroma filtering, a bilinear filtering, a Directional Cubic Convolution Interpolation, an Iterative Curvature-based Interpolation, a Edge-Guided Image Interpolation, and a deep learning based filtering method.

8. A method comprising:
encoding a plurality of pictures representing a video sequence in video data; and
encoding an information set representative of a filter in the video data, the information set comprising at least one first information specifying a condition to apply the filter based on a second information representing a dimension of the picture.

9. The method according to claim 8 wherein the filter is a resampling filter.

10. The method according to claim 8 wherein the filter is a separable filter and the parameters obtained from the information set specifies parameters of a horizontal filter and parameters of a vertical filter.

11. The method according to claim 8 wherein the filter is intended to be applied to luma and chroma components of each picture of the subset of pictures and the parameters obtained from the information set specifies parameters of the filter adapted for the filtering of the luma component and parameters of the filter adapted for the filtering of the chroma components different from the parameters of the filter adapted for the filtering of the luma components.

12. The method of claim 8 wherein the at least one first information specifies that the filter is applied only to pictures that have a resolution different from a maximum resolution.

13. The method of claim 8 wherein the information set comprises a third information specifying a filtering method in a plurality of filtering methods.

14. The method of claim 13 wherein the plurality of filtering methods comprises a luma filtering, a chroma filtering, a bilinear filtering, a Directional Cubic Convolution Interpolation, an Iterative Curvature-based Interpolation, an Edge-Guided Image Interpolation, and a deep learning based filtering method.

15. A device comprising electronic circuitry adapted for:
decoding a picture of a plurality of pictures representing a video sequence from video data;
obtaining parameters of a filter determined from an information set associated to the video data, the information set comprising at least one first information specifying a condition to apply the filter based on a second information representing a dimension of the picture; and
applying the filter on the decoded picture responsive to the information set.

16. The device according to claim 15 wherein the filter is a resampling filter.

17. The device according to claim 15 wherein the filter is a separable filter and the parameters obtained from the information set specifies parameters of a horizontal filter and parameters of a vertical filter.

18-21. (canceled)

22. A device comprising electronic circuitry adapted for:
encoding a plurality of pictures representing a video sequence in video data; and
encoding an information set representative of a filter in the video data, the information set comprising at least one first information specifying a condition to apply the filter based on a second information representing a dimension of the picture.

23. The device according to claim 22 wherein the filter is a resampling filter.

24-30. (canceled)

31. Non-transitory information storage medium storing program code instructions for implementing the method according to claim 1.
